(19) United States
(12) Patent Application Publication
(10) Pub. No.: US 2010/0323253 A1
(43) Pub. Date: Dec. 23, 2010

(54) Systems and Methods for Hydrogen Storage and Generation from Water Using Lithium Based Materials

(75) Inventors: Zhigang Zak Fang, Salt Lake City, UT (US); Jun Lu, Salt Lake City, UT (US); Hong Yong Sohn, Salt Lake City, UT (US)

Correspondence Address: THORPE NORTH & WESTERN, LLP., P.O. Box 1219, SANDY, UT, 84091-1219, US

(73) Assignee: UNIVERSITY OF UTAH RESARCH FOUNDATION, Salt Lake City, UT (US)

(21) Appl. No.: 12/280,232

(22) PCT Filed: Feb. 22, 2007
(86) PCT No.: PCT/US2007/004592

§ 371 Date: Jul. 9, 2010

Related U.S. Application Data
(60) Provisional application No. 60/775,939, filed on Feb. 22, 2006.
(60) Provisional application No. 60/818,652, filed on Jul. 3, 2006.

(51) Int. Cl. H01M 8/06; C01B 6/04; C01B 3/04

(52) U.S. Cl. 429/421; 423/646; 423/658.2

(57) ABSTRACT

A process for forming lithium hydride for use in storing and producing hydrogen is presented. The process includes reacting lithium oxide with water to form a regenerated lithium hydroxide and reacting the regenerated lithium hydroxide with magnesium to form magnesium oxide and a regenerated lithium hydride. The magnesium oxide can be regenerated to form magnesium. The process can further include reacting lithium hydride to form hydrogen and lithium oxide. Such hydrogen production can include reaction between lithium hydride and lithium hydroxide, and/or reaction between lithium hydride and water.

### RELATED APPLICATIONS

This application claims the benefit of earlier filed U.S. Provisional Patent Application No. 60/775,939, filed Feb. 22, 2006 and earlier filed U.S. Provisional Patent Application No. 60/818,652, filed Jul. 3, 2006, which are each incorporated by reference herein.

### FIELD OF THE INVENTION

The present invention relates generally to chemical storage and production of hydrogen, particularly rechargeable or continuous-process systems.

### BACKGROUND OF THE INVENTION

Owing to growing demand for efficient and clean alternative fuels, the development of technologies for using hydrogen as a fuel for civilian transportation vehicles has gained and is continuously gaining momentum in recent years. Hydrogen is undoubtedly one of the key alternatives to replace petroleum products as a clean energy carrier for both transportation and stationary applications. Interest in hydrogen has grown dramatically since 1990, and many advances in hydrogen production and storage technologies have been made during the past decade. However, there are still a number of elementally scientific and technological problems to be overcome before any large scale utilization of hydrogen could occur.

A major challenge for using hydrogen as a fuel today is to develop efficient and effective methods for hydrogen storage that can not only store hydrogen safely but also supply it where it is needed and when it is needed.

There are presently three generic mechanisms known for storing hydrogen in materials: absorption, adsorption, and chemical reaction. Overall, hydrogen storage in solids makes it possible to store larger quantities of hydrogen in smaller volumes at low pressures and at temperatures close to room temperature. Among them, the methods based on chemical reactions of solid inorganic hydrides are particularly important because they usually have larger inherent hydrogen storage capacities than that based on absorption or adsorption.

The chemical reaction-based hydrogen storage method can be further classified into two groups: 1) simple or complex metal hydrides and reactions that may be reversible on-board a vehicle by which hydrogen generation and storage take place by a reversal of the chemical reaction as a result of modest changes in the temperature and pressure, e.g. sodium alanate-based complex metal hydrides; and 2) chemical storage by which the hydrogen generation reaction is not reversible under modest temperature/pressure changes.

All these approaches, however, face formidable technical hurdles to overcome before they are feasible for practical applications. For example, a number of complex metal hydride materials with very high inherent potential H₂ storage capacity have demonstrated rapid, yet controllable, rates of dehydrogenation under practical conditions. Unfortunately, the reverse reaction of recharging these materials using high pressure H₂ gas is very difficult; while for some other hydride materials, the opposite situation is true.

In contrast, one prominent technical difficulty in using the hydrolysis of chemical hydrides for on-board storage applications is that most such hydrides react with water vigorously rendering the rate of hydrogen releasing reaction difficult to control. Further, the reaction products of many promising chemical hydrides such as NaBH₄, are not recyclable; in other words, they become solid waste products and require disposal.

When reversible reactions are used, there are a number of other critical requirements in addition to the reversibility, including that the kinetic rates of the reversible reactions within a reasonably low temperature range (100-300° C.) should be reasonably fast. When irreversible reactions involving chemical hydrides are used, for example the release of hydrogen by hydrolysis of NaBH₄, the hydrolysis reaction is spontaneous, highly exothermic and thus extremely difficult to control. Further the hydrolysis reactions are irreversible and the regeneration of the reactants (such as sodium borohydride) from the by-products of the reaction is very difficult.

In short, although substantial progress has been made in the past few years, progress has been hindered in practical application by many difficulties including size and weight considerations. None of the new materials or processes has demonstrated sufficient reversible hydrogen storage capacity in terms of either weight percentage or volumetric density of hydrogen that could enable them to become practically usable hydrogen storage materials. It is therefore also highly desired to develop a hydrogen storage material by which the hydrogen release is fast but tractable and the regeneration of the reactants is energetically and economically efficient.

### SUMMARY OF THE INVENTION

A new hybrid approach for hydrogen storage and production is presented, by which the release and uptake of hydrogen are reversible with good kinetics and within a practical energy-consumption range. More specifically, a new approach to regenerating materials that can be used to store and produce hydrogen is presented. This new process may be used for hydrogen production without relying on the use of fossil energy. Additionally, and in one aspect, the recyclable process which includes hydrogen production can be used without relying on external sources of hydrogen, or even by relying solely on water as the source of hydrogen.

This new approach entails forming lithium hydride for use in storing and producing hydrogen. The process includes reacting lithium oxide with water to form a regenerated lithium hydroxide and reacting the regenerated lithium hydroxide with magnesium to form magnesium oxide and a regenerated lithium hydride. In one aspect, the process can further include reacting the magnesium oxide with carbon to form a regenerated magnesium. Such reaction can, in some aspects, take place from about 1300° C. to about 1600° C. In another embodiment, the magnesium oxide can be thermally reduced to form regenerated magnesium. In still another approach, the magnesium oxide can be electrolytically converted to form regenerated magnesium.

In some aspects, it can be desirable to provide a process for forming lithium hydride without relying on hydrogen gas as a reactant. As such, in one aspect, the process can be substantially free of external sources of hydrogen as hydrogen gas (H₂). In a further aspect, substantially all external sources of hydrogen can be H₂O. In another aspect, the process can be substantially free of hydrogen gas as an intermediate during any step of the process.

In a further aspect of the present invention, the regenerated lithium hydride can be reacted to form hydrogen and lithium oxide. In one embodiment, the regenerated lithium hydride can be reacted with lithium hydroxide to form lithium oxide and hydrogen. In such case, a further step of forming a regenerated lithium hydroxide by reacting a first portion of the lithium oxide with water can be included. In the processes of the present invention, lithium hydroxide can comprise or consist essentially of lithium hydroxide hydrate. Where the process includes forming regenerated lithium hydroxide, it can be carried out substantially simultaneous to forming regenerated lithium hydride. Another process for reacting lithium hydride to form hydrogen and lithium oxide is the reaction of lithium hydride with water. Where hydrogen is produced in the process, it can be utilized as a fuel.

In one aspect, the lithium hydroxide and/or the regenerated lithium hydride can include a filler material.

In a specific embodiment, a method for storing and producing hydrogen to be used as a fuel can include reacting lithium oxide with water to form regenerated lithium hydroxide; reacting some of the lithium hydroxide with magnesium to form regenerated lithium hydride and magnesium oxide; regenerating the magnesium by reacting the magnesium oxide with carbon; and reacting the regenerated lithium hydride to form lithium oxide and hydrogen.

In accordance with the present invention, a system for storing and producing hydrogen can comprise a hydrogen storage enclosure. The system can further include a fuel cell operatively connected to the hydrogen storage enclosure and can include a lithium hydroxide, lithium hydride, magnesium, and water. A hydrogen outlet can be operatively connected to the fuel cell of the system. The magnesium, lithium hydroxide and/or lithium hydride can be supplied in removable cartridges.

Regenerated lithium hydroxide can be formed from a first portion of the lithium oxide, which is a product of the hydrogen-producing reaction, and water. The regenerated lithium hydride may be formed from further processing of a second portion of the lithium oxide. Also, the regenerating lithium hydroxide step and the regenerating lithium hydride step can be the initial part of a process or method utilizing the technology outlined herein. In such cases, the regenerated lithium hydroxide and regenerated lithium hydride produced through the reactive processes are not necessarily regenerated, but are produced initially therein. Typically, the lithium hydroxide and lithium hydride are initially provided as a starting material for the hydrogen-producing reaction. These materials can then be regenerated as described more fully below.

In another embodiment, the regenerated lithium hydride is produced via the reaction of lithium oxide with water to form intermediate lithium hydroxide. The lithium hydroxide can then undergo electrolytic refining to form lithium. The lithium can then undergo hydrogenation to form regenerated lithium hydride. Another embodiment includes subjecting the lithium oxide to an electrolysis process to produce regenerated lithium hydride.

Another process for regenerating lithium hydride includes reacting a second portion of lithium oxide with water to form an intermediate lithium hydroxide; reacting the intermediate lithium hydroxide with hydrochloric acid to form lithium chloride; and, subjecting the lithium chloride to electrolysis.

Yet another process for producing regenerated lithium hydride involves a process whereby the lithium oxide reacts with magnesium and hydrogen. This reaction forms regenerated lithium hydride and magnesium oxide. Further variations involve regenerating magnesium from the magnesium oxide produced in the reaction. This regenerated magnesium may then be used to react with lithium oxide and hydrogen to form regenerated lithium hydride. In one embodiment, magnesium may be regenerated from magnesium oxide through thermal reduction. In another alternative embodiment, magnesium may be regenerated from magnesium oxide through electrolysis. Magnesium can also be generated from magnesium chloride using electrolysis.

In yet another embodiment, a second portion of lithium oxide can be reacted with water to to form intermediate lithium hydroxide; the lithium hydroxide can be reacted with magnesium to form regenerated lithium hydride. In another, yet similar, embodiment, a second portion of lithium oxide may be reacted with water to form intermediate lithium hydroxide; the lithium hydroxide may be reacted with magnesium to form magnesium oxide, lithium and hydrogen; and the lithium and hydrogen may be reacted to form regenerated lithium hydride. The reaction of lithium with hydrogen to form regenerated lithium hydride may be conducted in a temperature-controlled environment.

By way of clarification, the lithium hydroxide and/or the lithium hydride may include filler materials for a variety of purposes such as, but not limited to, controlling reaction rates and/or stabilizing lithium compounds. For example, activated carbon can be used as a filler material.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIGS. 1a-1d show various schematic illustrations of lithium-based reversible reaction systems whereby water is added to and hydrogen is produced according to several embodiments of the present invention.

FIG. 2 is a basic illustration of the hypothesized mechanism of reaction of LiH with water as depending on particle size.

FIG. 3 shows a material balance for one embodiment of the present invention.

FIG. 4 shows a graphic representation depicting equilibrium reaction (LiOH+Mg) products (kmol) versus temperature (° C.).

FIG. 5 shows TGA curves for the reaction of LiOH.H₂O+3LiH mixture. Curve A shows the hydrogen generation by this reaction under atmospheric-pressure argon and a heating rate of 5° C./min. Curve B shows the temperature profile.

FIG. 6 shows TGA curves for the reaction of LiOH+LiH mixture. Curve A shows the hydrogen generation by this reaction under atmospheric-pressure argon and a heating rate of 5° C./min. Curve B shows the temperature profile.

FIG. 7 shows X-ray diffraction patterns from the reaction of a LiOH+LiH mixture after milling, dehydrogenation, and rehydrogenation by reacting the dehydrogenated products with water. Curve A, after milling. Curve B, after dehydrogenation at 100-300° C. Curve C, after reacting the dehydrogenated products with water and dried in vacuum at 80° C. overnight. Curve D, after reacting the dehydrogenated products with water and naturally dried in air at room temperature.

FIG. 8 shows X-ray diffraction patterns from the reaction of a LiOH+Mg mixture, A) after milling, B) after heat to 500° C. at argon atmosphere for 2 hours.

FIG. 9 shows a graphic representation depicting hydrogen generation versus time and system temperature. Curve A shows hydrogen generation of LiOH/LiH system under atmospheric argon and heating rate of 5° C./min. Curve B shows the temperature profile.

The drawings will be described further in connection with the following detailed description. Further, these drawings are not necessarily to scale and are by way of illustration only such that dimensions and geometries can vary from those illustrated.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a lithium hydroxide” is not to be taken as quantitatively or source limiting, reference to “a step” may include multiple steps, reference to “producing” or “products” of a reaction should not be taken to be all of the products of a reaction, and reference to “reacting” may include reference to one or more of such reaction steps. As such, the step of reacting can include multiple or repeated reaction of similar materials to produce identified reaction products.

### DEFINITIONS

In describing and claiming the present invention, the following terminology will be used in accordance with the definitions set forth below.

As used herein, “filler” and “fillers” refers to secondary materials mixed with primary materials. Fillers may be residual remains of previous reactionary processes, stabilizer material, material added to affect the physical properties of the primary material (i.e. flow-agents), or materials designed to affect the reaction rate.

As used herein, “form” and “forming” refer to any process whereby the specific material is created, structured, restructured, or produced; particularly where the material is the product of a chemical reaction.

As used herein, “practical temperature range” refers to an acceptable temperature range whereby the proposed process may occur, and generally is applicable to specific circumstances. This temperature may be less than 300° C., although what is determined to be practical is application and case specific.

As used herein, “reacting” refers to a process whereby a chemical reaction occurs. Where one material reacts with another material, a chemical reaction occurs between the two materials.

As used herein, “regenerating” and “regenerated” refer to processes whereby materials, once used in a process, are re-formed through further processing. In example, lithium hydroxide is used in a hydrogen-forming step that creates hydrogen and lithium oxide. In another processing step, regenerated lithium hydroxide is formed from the lithium oxide that was formed in the hydrogen-forming step.

As used herein, “portion” refers to a part or percentage of an identified material. A portion can include the whole material or merely a part thereof. For ease of discussion, portions may be labeled “first”, “second”, etc. Such distinction is to clarify the discussion herein only and is not meant to be limiting or to require distinct or second portions.

The terms “water” and “H₂O”, unless otherwise noted, are used herein interchangeably and refer both to liquid and gaseous forms (e.g. water vapor) but not to precursors or materials which may be converted into water at a later time.

As used herein, “thermally reducing” refers to production of a material having a lower oxidation state from a material having a higher oxidation state using a heating process. Typically, the reduction product has an oxidation state of zero, e.g. metallic magnesium, however this is not required.

As used herein, “temperature-controlled environment” refers to a defined volume where temperature can be manipulated using external controls such as heating coils, cooling water, or the like. Vessels or environments wherein temperature is carefully engineered by controlling rates of reaction via additives or concentrations, reactant/product flow rates, or the like would not be a temperature-controlled environment.

Unless otherwise indicated, “LiOH” includes the anhydrous and hydrate forms of lithium hydroxide. Furthermore, “LiOH” can include mixtures of anhydrous and hydrate forms.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 4 percent to about 7 percent” should be interpreted to include not only the explicitly recited values of about 4 percent to about 7 percent, but also include individual values and sub-ranges within the indicated range. Thus, included in this numerical range are individual values such as 4.5, 5.25 and 6 and sub-ranges such as from 4-5, from 5-7, and from 5.5-6.5; etc.

This same principle applies to ranges reciting only one numerical value. Furthermore, such an interpretation should apply regardless of the breadth of the range or the characteristics being described.

### BACKGROUND FOR THE INVENTION

In recent years, although there have been numerous materials systems studied as potential candidates for hydrogen storage applications, none of the materials known to date has demonstrated enough hydrogen capacity or desired energy efficiency. There are still considerable opportunities for discovery of new materials or material systems that could lead to advances in science as well as commercial technologies in this area. Lithium-based materials are most promising and attractive because they are one of the lightest metal elements and therefore their compounds usually contain higher gravimetric and volumetric density than hydrides of other materials. Examples of lithium based hydrides include LiH, LiAlH₄, and LiNH₂.

However, there are many technical hurdles that prevent these materials from becoming commercially viable, especially for on-board hydrogen storage for vehicular applications. The most important technical characteristics of these hydrogen storage materials include hydrogen storage capacity, hydrogen desorption/adsorption kinetics, overall system efficiency, waste materials, and reversibility. Many of the materials that are being studied today have fallen short of desired results for many reasons such as poor dehydrogenation kinetics, e.g. the rate of the dehydrogenation reaction is too slow, or the temperature required for dehydrogenation is too high, or the dehydrogenation reaction is not reversible or produces unwanted waste materials. Finding the material systems that have sufficient hydrogen storage capacity, reversible hydrogen desorption/adsorption reactions, and satisfactory reaction kinetics remains a great and monumental challenge.

It has a long been a great aspiration for scientists and engineers to produce hydrogen from water. Currently, hydrogen can indeed be produced from water by electrolytic dissociation of H₂O. The H₂ produced is then stored in high pressure tanks for usage. The main disadvantages of this approach are two fold. First, the electrolytic dissociation of H₂O consumes a great deal of energy, which brings the environmental benefits of this approach into question. Second, the method of storing H₂ in high-pressure tanks and then using it for civilian motor vehicles is also viewed as very risky for safety reasons.

### Embodiments of the Invention

The present invention provides a hybrid approach for hydrogen storage by which release and uptake of hydrogen are reversible with good kinetics within a practically feasible temperature range (<300° C.). In particular, the recharge of hydrogen can be accomplished by reaction with water, rather than high pressure H₂ gas. Further, the method of the present invention can also be used for hydrogen production without relying on the use of fossil energy.

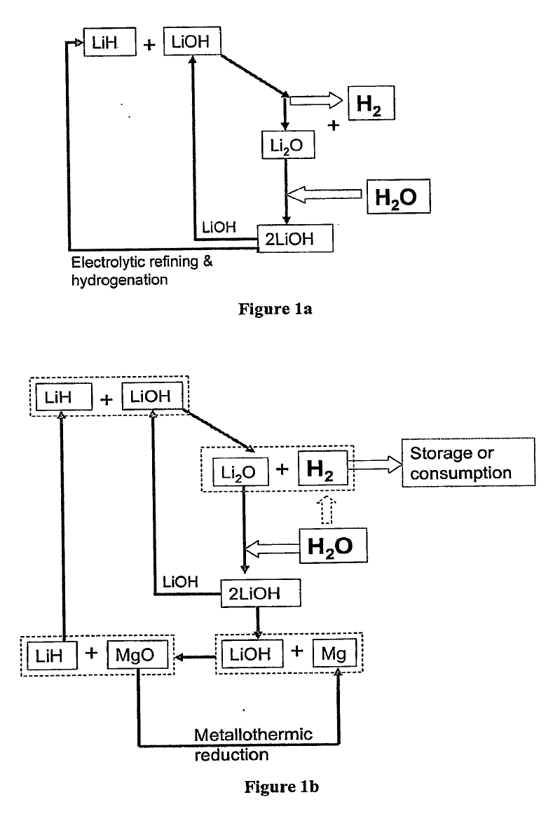

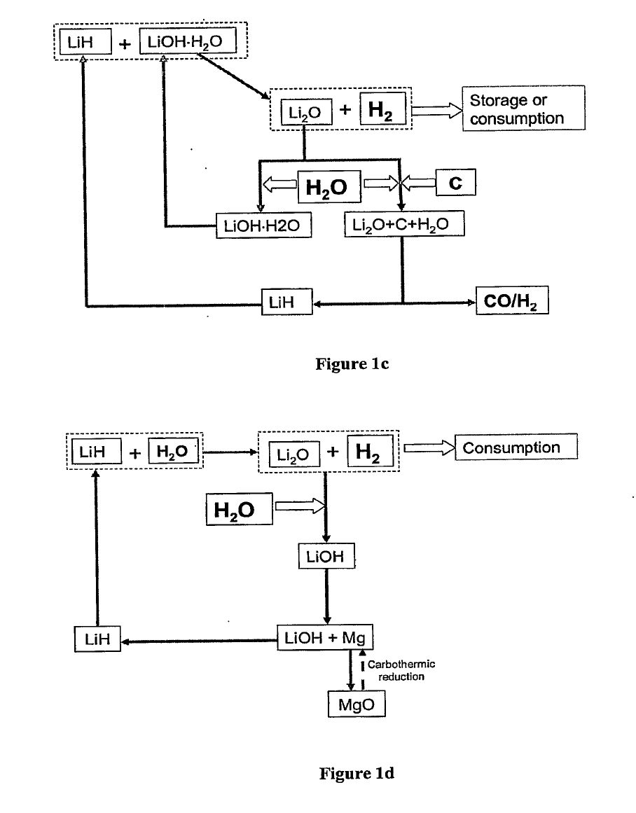

The processes of the present invention offer approaches whereby hydrogen can be readily produced. The system generally requires only the addition of water to the system to produce the desired hydrogen. The system is based on a series of chemical reactions as described in more detail below. In a first stage, hydrogen can be produced through the reaction of lithium hydroxide and lithium hydride. In a second stage, the lithium hydroxide can be regenerated. A third stage can be used to regenerate the lithium hydride. The reaction system is cyclical as it can start and/or stop at any point. FIGS. 1a-1d show the cyclic nature of the reaction system. Further, the stages may occur simultaneously, particularly the second and third stages wherein the reactants for the first reaction are regenerated. Further, regeneration of the lithium hydride and/or lithium hydroxide can involve the use of magnesium. The specifics of each stage are further examined below.

In another aspect of the invention, the regeneration of materials used for the production of hydrogen is detailed. This new approach entails forming lithium hydride for use in storing and producing hydrogen. The overall process can include reacting lithium oxide with water to form a regenerated lithium hydroxide and reacting the regenerated lithium hydroxide with magnesium to form magnesium oxide and a regenerated lithium hydride. In one aspect, the process can further include reacting the magnesium oxide with carbon to form a regenerated magnesium.

### Hydrogen Production

A safe and efficient means of producing hydrogen can be based on a reaction cycle that utilizes a series of relatively simple reactions, yet has tremendous results. Collectively this reaction cycle is a reversible hydrogen storage cycle. The processes of the present invention can also generate about 50% to about 100% of the hydrogen indirectly from water without relying on electrolytic dissociation of water or reforming of natural gas.

FIGS. 1a-1d are schematic illustrations of several reaction schemes in accordance with the present invention. For hydrogen production, lithium hydride and lithium hydroxide (LiOH) or lithium hydroxide monohydrate (LiOH.H₂O) are reacted according to Equation (1):

LiOH.H₂O+3LiH→2Li₂O+3H₂ (1a)

LiOH+LiH→Li₂O+H₂ (1b)

Equation (1) is represented by Equation (1a) and Equation (1b) wherein either or both reactions may be used as a hydrogen-producing step. The Equations (1a) and (1b) may produce, respectively, up to about 8.8% and about 6.3% of hydrogen from about 100° C. to about 300° C. The technical targets of hydrogen storage capacity (on a system base) set by DOE are 6 wt % and 9 wt % by 2010 and 2015, respectively. The recognized state-of-the-art material, NaAlH₄, has approximately 5.6 wt % potential capacity (on material basis only). Additionally, Equation (1) of the present invention can be used for on-board hydrogen generation.

Ideal hydrogen content of Equation (1b) is about 9.2%. For the purpose of on-board hydrogen storage, the challenge of using this reaction is to control the reaction rate because Equation (1b) would proceed initially very rapidly, releasing most of the hydrogen. The initial rapid reaction is due to the reaction of LiH with the H₂O molecule. At present, it is believed that the dehydrogenation Equations (1a) and (1b) take place in the ranges of 25-70° C. and 120-350° C., respectively. It is desirable for Equation (1a) to be controlled and for the reaction temperature of Equation (1b) to be lowered to below 150° C. To achieve sufficient control of reaction rates and allow reduction of reaction temperature for Equation (1b), various catalysts can be chosen which can include platinum group metals, followed by nickel, impregnated on solid surfaces, and/or composites or alloys thereof. These are among the most active catalysts for reactions involving hydrogen as the reactants.

Practical application of the present invention can depend on the kinetics of the hydrogen desorption process. Equations (1a) and (1b) have large negative free energy values and thus will go to completion. While this indicates that the reactions are very favorable thermodynamically, this also means that the reactions cannot be controlled by hydrogen pressure because of its extremely high equilibrium value. Therefore, hydrogen release from these reactions rely on their reaction kinetics. In the temperature range of interest for hydrogen release of greater than 300° C., the two reactants are solids (melting points of LiH and LiOH are, respectively, 680° C. and 450° C.). For reactions between solids, the major factors that affect the reaction rate include temperature, particle sizes of the solids, contacting method, and catalyst used. Further, in this case there are two reactions for hydrogen release which start taking place at different temperatures. This factor can be taken advantage of by forming mixtures containing different amounts of LiOH.H₂O and LiOH to control the temperature dependence of the hydrogen release rate. Adjustment of relative amounts within the mixture can be readily performed through routine experimentation to find optimal ratios for a particular application. This mixture approach can have application on cold start and cruising phases of automobile operations. Thus, an additional factor affecting the reaction rate is mixing ratio of LiOH.H₂O/LiOH.

Another method of formation includes the reaction of lithium hydride directly with water. In this system, hydrogen release is accomplished by the reaction of lithium hydride with water, which releases hydrogen based on the following reaction:

LiH(s)+0.5H₂O→0.5Li₂O(s)+H₂(g) (1c)

Equation (1c) has a hydrogen storage capacity of 11.8 wt %. Previously, the prevailing thought has been that this reaction produces LiOH, which yields a lower percentage of hydrogen per mass of (LiH+H₂O) at 7.7%. However, the reactions between LiH and H₂O can form either Li₂O and/or LiOH depending on water content and temperature conditions. Equation (1c) is thermodynamically favorable and exothermic. In reality, the reaction mechanism between LiH and H₂O is rather complex with respect to the competing reactions of forming Li₂O or LiOH and that the kinetic control of Equation (1c) is challenging and the regeneration of LiH can be difficult.

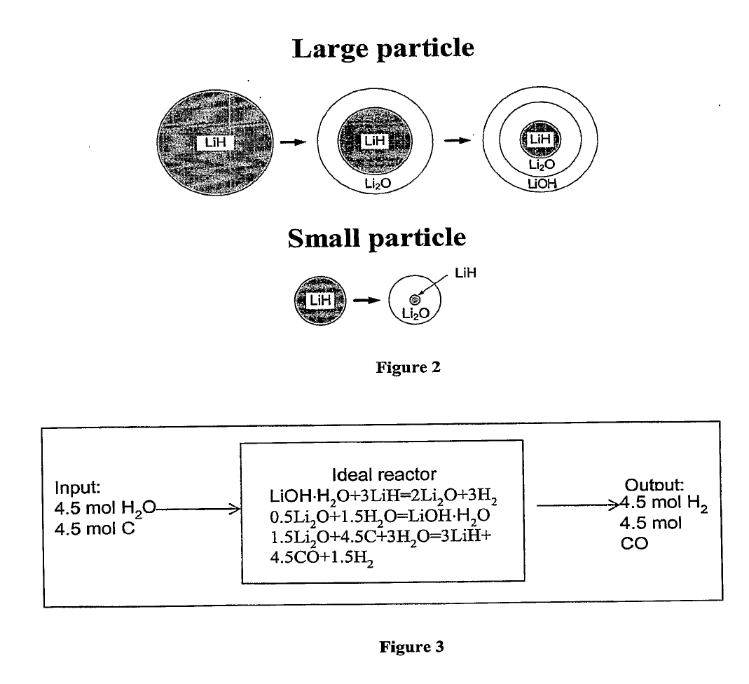

Without being bound by any theory, it is presently believed that the reaction can be determinative, at least in part, by the particle size of the reactants. Therefore, reaction conditions can be controlled such that the reaction will continue only until Li₂O is formed with little LiOH formation. A major factor for promoting this selectivity can be the size of LiH particles. This can be seen with the help of FIG. 2. It is presently believed that Li₂O is first formed before LiOH starts forming. The reaction of a LiH particle is expected to occur according to FIG. 2. After some duration of reaction, the remaining LiH will be surrounded by a layer of Li₂O, and this in turn will be covered by LiOH. The thickness of the Li₂O layer formed before LiOH starts to form will be similar in a large and a small particle. This means that the highest mass fraction of hydrogen will be obtained when all the LiH is converted to Li₂O before LiOH starts forming. A high conversion to Li₂O can be obtained with smaller LiH particles. On the other hand, since smaller particles may give rise to increased difficulties of material handling, an optimum particle size can be determined that will result in a high hydrogen mass fraction and will still allow easy handling. Such optimum particle size is dependent at least somewhat on conditions of material handling and reaction vessel and conditions. Furthermore, even if all LiH is converted to LiOH, the hydrogen mass content is quite substantial at 7.7 wt %. In one aspect, the rate of the hydrogen release reaction can be controlled primarily by the rate of water supply, because the reaction itself is sufficiently rapid to make water concentration the primary rate limiting factor.

### Lithium Hydroxide Regeneration

For the systems which use lithium hydroxide as a reactant for producing hydrogen, the reaction product, lithium oxide (Li₂O), may then be used to reproduce lithium hydroxide (LiOH) or the hydrate, designated regenerated lithium hydroxide, by reacting with water, based on Equation (2):

Li₂O+H₂O→2LiOH (2a)

Li₂O+3H₂O→2LiOH.H₂O (2b)

One mole of LiOH (or the hydrate) of the products of Equation (2) may be reused for the hydrogen production by Equation (1). The other one mole of LiOH may be used for reproduction of lithium hydride, which can be accomplished in several different approaches, and will be discussed in the following section.

The Equations (1) and (2) constitute a “reversible” hydrogen generation system. It is noted that LiOH.H₂O may also be used in place of LiOH, although other hydrates can also be useful.

### Lithium Hydride Regeneration

Once the stored hydrogen is released via one of the hydrogen releasing mechanisms described, the starting materials can be regenerated to repeat the process. In particular, to resume any of the noted hydrogen producing reactions, additional LiH is needed. A variety of methods for producing, or regenerating lithium hydride are thus disclosed. Many of the regeneration methods use LiOH as a reactant. In such cases, Equation (2) above can be utilized to transform lithium oxide to lithium hydroxide by reaction with water.

In one aspect, LiH can be produced by the electrolytic reaction of LiOH according to the following reaction:

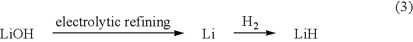

Now, in Equation (2), two moles of LiOH are produced of which one mole may be used in Equation (1). The second mole of LiOH may then be used in Equation (3). The product of Equation (3), LiH, can in turn be used in Equation (1) to produce H₂. This basic reaction cycle is illustrated in FIG. 1a.

FIG. 1a illustrates that the reaction cycle is self-recycling with respect to lithium. The only consumable in this cycle is water. The only additional process and hence energy required is the production of LiH from LiOH. The refining process, Equation (3), produces metallic Li from LiOH and then the Li metal becomes LiH by reaction with H₂, which requires H₂ gas that must be produced and supplied separately. The H₂ gas used in the reaction can be obtained from the initial hydrogen producing reaction. Alternatively, H₂ gas can be supplied by alternate methods such as electrolytic dissociation of H₂O or reforming of hydrocarbon gases.

Considering Equations (1)-(3) collectively from a chemical balance perspective, it can be seen that about 50% of the H₂ produced in Equations (1a) and (1b) comes from Equation (2), which is an exothermic reaction that generally requires no additional energy input. In other words, this invention is not only an effective technique for reversible hydrogen storage applications, but also a hydrogen production technology. Out of the total hydrogen output, only about 50% must be supplied by the electrolytic dissociated H₂O. The other 50% comes from a simple exothermic reaction of water with Li₂O.

There are several other process routes that could be used to produce Li and LiH. One of which is that LiOH can be reacted with HCl to produce LiCl. Then, Li can be produced by electrolysis of LiCl. Yet another approach is to do electrolysis of Li₂O directly.

An alternative approach to regenerate LiH is a carbothermic reduction process that can be used to regenerate LiH directly. A suitable LiH regeneration method can be represented by

Li₂O+3C+H₂O(g)→2LiH+3CO+H₂ (4)

Equation (4) can be carried out at high temperatures (e.g. temperatures greater than 1200° C.). This approach can be compared with other options including straight carbothermic reduction of Li₂O to produce Li, electrolysis of Li₂O, and an indirect approach of using Mg to reduce LiOH. In some environments, this approach can be preferred to other possible approaches with respect to both energy efficiencies and costs. The gaseous product of Equation (4), a mixture of CO and H₂, can also be utilized either as a fuel or for H₂ production using relatively new separation technologies, e.g. hydrogen separation membranes, or other technologies being developed for fuel cells. Hydrogen gas can be used in Equation (4) as a reactant instead of water. However, the use of water vapor can be advantageous because no hydrogen produced from other sources would be needed for the complete regeneration of the reactants for Equation (1).

Reactions taught herein in combination constitute a hydrogen generation and regeneration cycle. Several exemplary cycles are schematically illustrated in FIGS. 1a-1d. Unlike typical on-board reversible hydrogen storage materials, the re-charging of hydrogen is not done by high pressure H₂ gas but by the reaction of Li₂O with water. Lithium metal is recycled within the cycle. In some embodiments, the only net consumptions of this proposed cycle is carbon and water, both abundant in nature. Compared to other chemical storage materials that rely on off-board regeneration, the advantage of this concept is that the regeneration of the materials is based on simple chemistry and metallurgical processes and is less energy intensive.

One advantage of the present invention is that all hydrogen that is produced can be sourced from water. However, as pointed out in the carbothermic reaction, in order to regenerate LiH, high temperature reaction is usually required. The energetic viability of the present invention can be illustrated using an energy balance calculation for one embodiment and based on ideal condition assumptions and the inputs/outputs as shown in FIG. 3. The energy required for the production of one mole of H₂ is 175 kJ. Because the heat of combustion of H₂ gas is 286 kJ/mol, the energy content of the hydrogen versus the energy required for regeneration of the reactants is thus 163%. In order to assess a more conservative scenario of not recovering heat from hot products, the energy balance calculations are carried out by assuming Equation (4) is carried out at 1300° C. In this case, the energy required for production of one mole of H₂ is 346 kJ. Thus, the energy content of H₂ is 83% of the energy required for regeneration. In each case, the embodiments are energetically favorable. Similar energy balance analyses will depend on the specific embodiments used. Still another alternative approach for regeneration of LiH can include the use of magnesium. After Equation (1), about half of the Li₂O can be used to react with H₂O to produce LiOH, which can be put back into Equation (1). The remaining Li₂O can be used to react with magnesium metal, Mg, and H₂ (which can be taken from the product of Equation (1)) according to the following reaction equation:

½Li₂O+Mg+½H₂→LiH+MgO (5)

The products of Equation (5) include LiH and MgO. LiH can then be used in Equation (1) to produce H₂, while MgO can be processed to produce regenerated Mg metal. Typically, there are two types of processes for making Mg metal powder: thermal reduction process and electrolysis process. Energy consumptions of these two types of processes are similar. In general, Mg metal production is less energy intensive than that of Li. In fact, Mg is a relatively low cost metal. Therefore, using Mg to reduce LiO and regenerate LiH is a preferred approach. More specifically, the MgO produced in Equation (5), or any of the following reactions utilizing magnesium, can be reduced by ferrosilicon to regenerate Mg.

As one embodiment, by which substantially all of the hydrogen produced in the process is generated from water, the reaction product of Equation (2), LiOH, can be used to react with Mg based on the following equation:

2LiOH+2Mg→2Li+2MgO+H₂ (6)

Based on thermodynamic calculations, Equation (6) is even more favored that reaction (5). Depending on the temperature of the reaction, the reaction product Li in Equation (6) may be in the form of either solid, liquid, or vapor phase. And, when the temperature is controlled at appropriate levels, the Li and H₂ will form LiH directly. Then, the reaction Equation (6) becomes

LiOH+Mg→LiH+MgO (7)

The above reaction has been demonstrated by the present inventors with a ΔH° (298K) of −204.642 kJ/mole. LiH was formed at 600° C. LiH from the above reaction can be separated from MgO as a liquid if the reaction is carried out above its melting point 680° C. but below its decomposition temperature (720° C.). This technique can also be suitable because the equilibrium pressure of LiH at 700° C. is very small (˜0.5 psi). Further, decomposition of LiH can be suppressed using pressure. For example, using H₂ gas at a higher pressure than that of the equilibrium pressure of the LiH with H₂, can suppress the decomposition of LiH while melting and separating it from MgO.

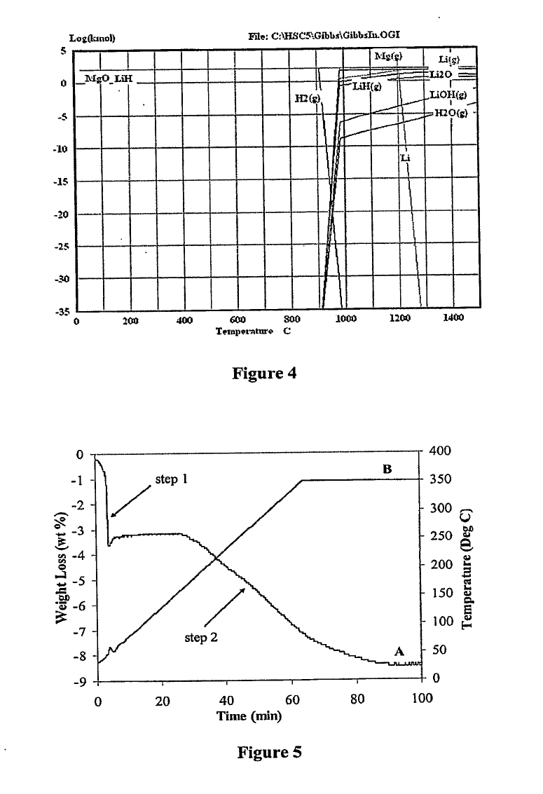

FIG. 4 illustrates the equilibrium reaction products of Equations (6) and (7) as a function of temperature (i.e. Gibbs free energy versus temperature). Using this new approach to re-charge hydrogen, the whole cycle of hydrogen generation from water is illustrated by FIG. 1b. The MgO produced in Equation (3) can then be reduced using various methods. For example, ferrosilicon can be used to regenerate Mg as described in more detail below.

Group IA and IIA elements such as sodium Na, calcium Ca, magnesium Mg, potassium K, and barium Ba, undergo both similar reactions as Equation (1) and Equation (2). Therefore, these elements can also be used for hydrogen generation and storage. However lithium is currently preferred due to its light weight and high hydrogen content of hydrogen-containing lithium compounds. Many other metal hydrides, such as AlH₃, NiH₂, and TiH₂, can undergo similar reaction as Equation (1). However, the regeneration of their respective hydroxides using similar reaction as Equation (2) can be difficult because the reaction of their oxides with water is thermodynamically unfavorable. Therefore, lithium and lithium oxide (Li₂O) are uniquely suited for hydrogen generation and regeneration on the basis of Equation (1) and Equation (2). An important advantage of using this approach (Equations (6) and (7)), is that substantially all hydrogen (100%) released in Equation (1) is originated from H₂O by Equation (2). Therefore, as an alternative approach for hydrogen generation, all hydrogen is produced from water without having to rely on electrolysis of water. In one aspect, substantially the only significant energy consumption step of the entire cycle can be the regeneration of Mg metal, which can consume less energy than and is more environmentally friendly than either reforming natural gas or electrolysis of water.

The combination of a hydrogen-producing step, a lithium hydroxide regenerating step and a lithium hydride regeneration step constitutes a hydrogen generation and regeneration cycle. From a hydrogen storage perspective, it is primarily an off-board reversible storage technique as oppose to storage techniques that use on-board reversible materials. A unique feature of this method is that the only consumable in this cycle is water.

In some aspects, the total cycle, including regenerating reactants (e.g. LiOH, LiH, Mg) can be configured so as to be completed without relying on hydrogen gas as a reactant. As such, in one aspect, the process can be substantially free of external sources of hydrogen as hydrogen gas (H₂). In a further aspect, substantially all external sources of hydrogen can be H₂O. In another aspect, the process can be substantially free of hydrogen gas as an intermediate during any step of the process. Further, the hydrogen-producing step, the regenerating lithium hydroxide step and/or the regenerating lithium hydride step may occur substantially simultaneously. Additionally, one or more of the regeneration steps may occur substantially sequentially. Further, the steps can be performed substantially continuously. FIGS. 1a-1d and the processes above also demonstrate that hydrogen can be produced from water using relatively easily controllable exothermic reactions, provided there is a supply of magnesium metal (or using other methods) for reproduction of LiH. Therefore, this is also an alternative hydrogen production method.

### Magnesium Regeneration

Consistent with the overall invention, a method for forming regenerated lithium hydride can entail forming lithium hydride for use in storing and producing hydrogen. The process can include reacting lithium oxide with water to form a regenerated lithium hydroxide and reacting the regenerated lithium hydroxide with magnesium to form magnesium oxide and a regenerated lithium hydride.

In one aspect, the process can further include reacting the magnesium oxide with carbon to form regenerated magnesium. Such reaction to form regenerated magnesium can, in some aspects, take place from about 1300° C. to about 1600° C. In another embodiment, the magnesium oxide can be thermally reduced to form regenerated magnesium. In still another approach, the magnesium oxide can be electrolytically converted to form regenerated magnesium.

In accordance with the present invention, therefore, and in one specific embodiment, a method for storing and producing hydrogen to be used as a fuel can include reacting lithium oxide with water to form regenerated lithium hydroxide; reacting a portion of the lithium hydroxide with magnesium to form regenerated lithium hydride and magnesium oxide; regenerating the magnesium by reacting the magnesium oxide with carbon; and reacting the regenerated lithium hydride to form lithium oxide and hydrogen.

Magnesium can also be regenerated using a carbothermic reduction. A high temperature carbothermic reduction process can proceed according to Equation (8):

MgO(s)+C(s)→Mg(g)+CO(g) (8)

This reaction can be carried out at very high temperatures (e.g. greater than 1200° C.) and the product gas phase can be quenched to minimize the re-oxidation of Mg. The reaction product of Equation (8) may contain Mg metal as well as MgO impurities. However, because Mg will be reused in regenerating LiH, the presence of a small percent of MgO is generally acceptable.

As shown by FIG. 1a and Equation (7), magnesium metal can be required to reproduce reactants for the hydrogen producing Equation (1). Typically, Mg metal can be produced industrially by either the electrolysis of MgCl₂ or the reduction of MgO. Since MgO is the byproduct of some of the lithium hydride reproduction steps, this MgO can be directly recycled to produce Mg. The reduction of MgO can be accomplished by mixing MgO with ferrosilicon based on the following reaction:

(Fe,Si)(s)+MgO(s)→Fe(s)+SiO₂(s)+Mg(g) (9)

The reduction process is usually carried out at temperatures greater than about 1000° C. Typically a large quantity of electricity can be required to produce Mg, which electricity can be supplied by either burning of fossil energy or the use of renewable energy.

Because Mg is used in the current method as an independent reactant, it therefore can be produced independently in remote locations where renewable energy is readily available without affecting either the effectiveness of the hydrogen producing Equation (1) or the reproduction of the reactants for Equation (1). For example, hydropower is a matured technology that can be very effective. When the reduction of MgO, i.e. the reproduction of Mg metal, is performed using hydropower, by using the reaction cycles described herein, hydrogen can be produced from water without significant use of fossil energy.

### Hydrogen Release Reaction

Thermogravimetric analysis (TGA) and X-ray diffraction (XRD) methods were used to verify reaction path and products. FIG. 5 shows the TGA curve of the H₂ release reaction Equation (1). This was carried out by mixing LiH and LiOH.H₂O powder under carefully controlled conditions to avoid reaction during mixing. The sample was then analyzed using TGA under argon atmosphere with a heating rate of 5° C./min. It can be seen that a total of 8.5 wt % of hydrogen was released within the examined temperature range, much occurring before 240° C. Assuming complete dehydrogenation of LiOH.H₂O/3LiH mixture, the maximum amount of H₂ produced would be 8.8 wt %. The result shown in FIG. 5 hence represents a yield of 96%. FIG. 5 also shows that the dehydrogenation is accomplished in two steps. The first step between room temperature to 80° C. corresponds to Equation (10) and the second step between 120 and 350° C. corresponds to Equation (1b).

LiOH.H₂O+3LiH→2LiOH+H₂ (10)

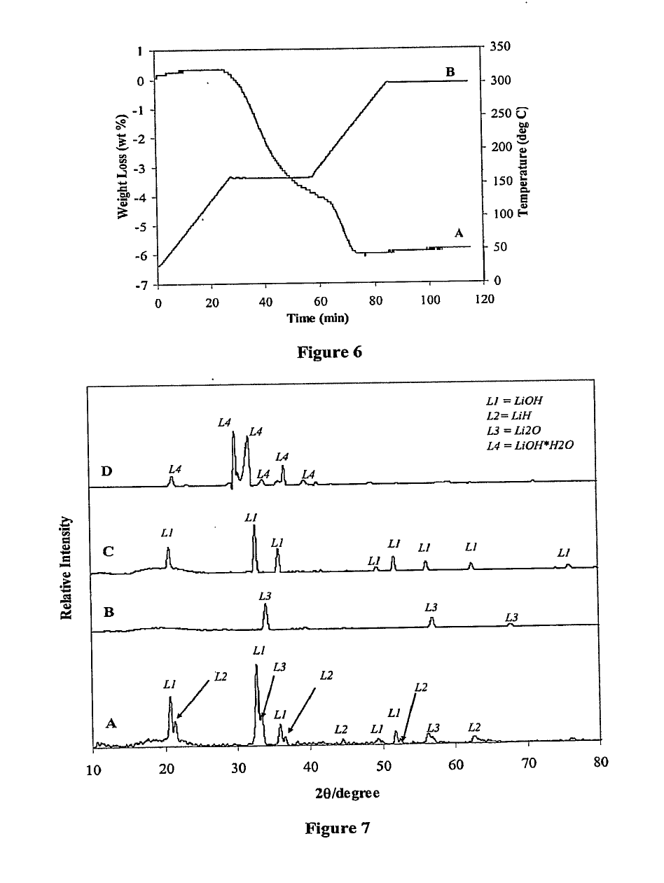

Equation (10) is essentially a hydrolysis reaction of LiH. However, because the water molecule in lithium hydroxide monohydrate is in crystalline form, the rate of Equation (10) is controllable. The lithium hydroxide monohydrate can be formed in a secondary reactive process, internal or external to the process, or may be introduced as a raw-material. FIG. 6 shows the TGA curve of the H₂ release reaction Equation (1b) starting with a ball milled mixture of LiH and LiOH. The sample was then analyzed using TGA under argon atmosphere with a heating rate of 5° C./min. A total of 6.0 wt % of hydrogen was released within the examined temperature range, which represents a yield of 95%.

X-ray diffraction analysis was carried out on the raw materials as well as on the reaction products. FIG. 7 shows the XRD patterns of selected samples before and after dehydrogenation. Crystalline phases are identified by comparing the experimental data with JCPDS files from the International Center for Diffraction Data. In FIG. 7, pattern A, which represents the XRD result for the sample before dehydrogenation, is attributed to the phases of the reactants LiOH and LiH. Pattern B shows the XRD result for the sample after dehydrogenation indicating that LiOH and LiH are absent in the samples by being consumed by the reaction. In this pattern, all the peaks can be indexed to be that of Li₂O, which indicate that the Equation (1) is complete.

### Hydrogen Uptake Reaction

To demonstrate the uptake of hydrogen, Li₂O from Equation (1) may be reacted with water according to Equation (2). Pattern C and D of FIG. 7 shows the XRD result of the product of Equation (2). Thus, LiOH or the hydrate, which is one of the reactants of the hydrogen producing reaction (1), may be reproduced by Equation (2). In other words, the dehydrogenation product may be partially re-hydrogenated.

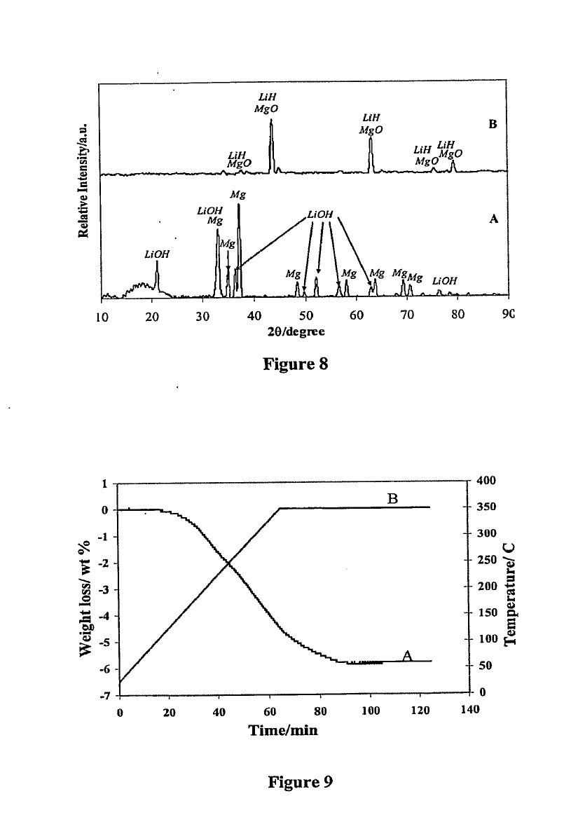

The complete regeneration of the reactants for Equation (1), however, also needs the replenishment of LiH. Using the product of Equation (7), lithium hydride can be produced in a number of different ways including the electrolysis of Li₂O or LiCl and the hydrogenation of lithium metal. A more preferable approach is to use magnesium metal to react with LiOH based on Equation (7). The experimental confirmation of Equation (7) is shown in FIG. 8. The products of Equation (7) include LiH and MgO which can be separated. LiH can then be used in Equation (1) to produce H₂, while MgO can be subjected to a reduction process that produces Mg metal from MgO. Depending on the temperature of the reaction, the reaction products of Equation (7) may be in the form of either solid, liquid, or vapor phase. When the temperature is controlled at a sufficient level, the Li and H₂ can form LiH in the vapor phase and can be collected separately from MgO.

With regard to the reversibility of the hydrogen uptake and release reactions, the above discussion shows that the method of the present invention is different from that of conventional methods of using reversible solid hydride materials. For conventional reversible hydrogen storage materials, a given reaction is reversible for either the release or uptake of hydrogen under controlled conditions. Equation (1) for releasing hydrogen according to the hybrid method described herein, however, is generally not reversible. In fact, using basic thermodynamic data, it can easily be shown that the hydrogen release Equation (1) is an exothermic reaction because the theoretical enthalpy of Equation (1) is ΔH° (298K)=−134.325 and −19.838 kJ/mol, respectively, for Equation (1a) and (1b). Hence, the reversible reaction of Equation (1) by using high pressure H₂ gas is unlikely under practically feasible conditions. Instead, the recharge of hydrogen according to this method can be accomplished by separate reaction that reproduces the reactants of the hydrogen release reaction. These separate reactions are preferably carried out off-board. A distinctive feature of this method is that all the hydrogen produced by Equation (1) can be derived about 100% from water. In other words, the hydrogen storage system is recharged with water.

### Hydrogen Production

Hydrogen gas is typically produced commercially today by two methods: 1) the reforming of natural gas and 2) the electrolysis of water. Although the latter method generates hydrogen from water, it still relies heavily on fossil energy for generation of the electricity that is required to carry out the electrolysis process. Considerable research is underway to integrate power generation from renewable energy sources such as wind and solar energy with the electrolysis of water so that the production of hydrogen is free of the use of fossil energy. The hybrid method of the present invention provides another alternative for hydrogen production that is free of fossil energy.

When the current invention is viewed as a method for hydrogen storage, the H₂ released by Equation (1) can all be used for application. Therefore, the storage capacity of the current invention is about 6-8.8%. As previously stated, because the hydrogen re-charging of the current system involves reactions with water and hydrogen, off-board re-charging may be preferred.

Unlike many other off-board hydrogen storage methods relying on hydrolysis of complex boron-metal hydrides, this system does not generate permanent waste. The regeneration process is simple and can be configured to run with metals that are recyclable. The entire process is environmentally benign.

In the embodiment of hydrogen produced by the process of Equation (1a) or (1b), an important note is that 50-100% of the hydrogen generated in Equation (1) comes from Equation (2), i.e. water, H₂O. In other words, only 50% or none of the hydrogen produced in the process relies on the traditional source of hydrogen such as reforming of natural gas or electrolysis of water.

When the current invention is applied to the generation and production of hydrogen, net hydrogen is produced through the entire cycle. The source of the net hydrogen production is water via Equation (2). For example, one may assume one mole of hydrogen is produced and consumed in Equation (1). The question is where this hydrogen originates. Using traditional technology, the hydrogen originates either from reforming of hydrocarbon gases or electrolysis of water. Using the present invention, 50% or less of the hydrogen can be supplied by the traditional source, while 50-100% of the hydrogen is supplied by Equation (2), i.e. water. Therefore, dependence on reforming natural gas to obtain hydrogen is cut in half or completely removed.

The other factor that affects the competitiveness of the current process compared to other hydrogen production methods, namely reforming of natural gas, or hydrolysis of water, relies on the comparison of the energy consumption of the re-production of Li and LiH.

The following examples illustrate various methods in accordance with the present invention. However, it is to be understood that the following are only exemplary or illustrative of the application of the principles of the present invention. Numerous modifications and alternative compositions, methods, and systems can be devised by those skilled in the art without departing from the spirit and scope of the present invention. The appended claims are intended to cover such modifications and arrangements. Thus, while the present invention has been described above with particularity, the following Example provides further detail in connection with one specific embodiment of the invention.

### EXPERIMENTAL RESULTS

### Example 1

The starting materials, lithium hydroxide (LiOH, 98%), lithium hydroxide monohydrate (LiOH.H₂O, 98%), lithium hydride (LiH, 95%), magnesium powder (Mg, 98%) were purchased from Aldrich Chemical. All of the starting materials were used as received without any further purification. To prevent samples and raw materials from undergoing oxidation and/or hydroxide formation, they were stored and handled in an argon-filled glove box.

All the mixtures were mechanically milled in an SPEX 8000 high-energy mill under argon atmosphere for 30 min. After milling, the samples were transferred to a glove box. The thermal hydrogen release properties of the mixtures were determined by a thermogravimetry analyzer (TGA) (Shimadzu TGA50) upon heating to 350° C. at a heating rate of 5° C./min. To avoid any exposure of the sample to air, this equipment was set inside the argon-filled glove box equipped with a recirculation system.

The identification of reactants and reaction products in the mixture before and after thermogravimetric analysis was carried out using a Siemens D5000 model X-ray diffractometer with Ni-filtered Cu Kα radiation (λ=1.5406 Å). A scanning rate of 0.02°/s was applied to record the patterns in the 2θ range of 10° to 90°. In addition, it is noted that the amorphous-like background in the XRD patterns is attributed to the thin plastic films that were used to cover the powders.

### Example 2

Equation (1) was carried out by mixing LiH and LiOH powder using a mortar and pestle. The mixed powder was then placed in the thermogravimetric analysis (TGA) instrument. FIG. 9 shows the hydrogen evolution from mechanically milled mixtures of LiH/LiOH during heating up to 350° C. The sample was run under argon atmosphere with a heating rate of 2° C./min. Temperatures were held constant at time points when there was definitive weight loss, indicating a decomposition reaction, and until the reaction step was complete. It can be seen that a total of 6.0 wt % of hydrogen was released within the examined temperature range, and the majority occurred before 240° C. Assuming complete dehydrogenation of LiOH/LiH mixture, the maximum amount of H₂ produced would be about 6.25 wt. %. So, the hydrogen collected represents a yield as high as 96%.

X-ray diffraction analysis was carried out on the raw materials as well as on the reaction products. Crystalline phases were identified by comparing the experimental data with JCPDS files from the International Center for Diffraction Data. The results show that LiOH and LiH are absent in the samples, indicating that they are consumed by the decomposition and some new compounds formed. The results pointed to a very complete reaction. The analysis on the sample after dehydrogenation and reaction with water showed that LiOH recycled back.

### Example 3

In order to assess the energetic viability of the proposed technology, a preliminary energy balance calculation based on a conservative situation of not recovering heat from the hot products has been carried out by assuming Equation (8) is carried out at 1300° C. The energy required for production of one mole of H₂ is 454kJ. Because the heat of combustion of H₂ gas is 286 kJ/mol, the energy content of H₂ is 63% of the energy required for regeneration. This more than satisfies the requirement set by DOE for off-board regenerated storage materials. Those results were compared with additional technologies. The results are in Table 1.

TABLE 1

| | Candidate Materials | | | | | |
|---|---|---|---|---|---|---|
| | On-board reversible Metal Hydride | | | | | |
| | MgH₂ | | | | Chemical Hydrides | |
| | doped | | | | NaBH₄ | Proposed Method |
| Properties | w/Ni | NaAlH₄ | LiH + LiNH₂ | ½MgH2 + LiBH₄ | Hydrolysis | LiH + H₂O |
| Potential | 7.6 | 5.6 | 6.5 | 11.4 | 6.4 | 11.8 |
| reversible wt % | | | | | | |
| H₂ | | | | | | |
| Temp. of Release | 200~300 | 180-220 | 200~300 | 450 | Room temp. | Room temp. to <300 |
| (° C.) | | | | | | |
| Rate of Release | Slow | Good | Good | Slow | Extremely fast | Good |
| Rate of | Slow | Good | Good | Slow | N/A Need | N/A. Need |
| Recharging | | | | | regeneration | regeneration |
| Isothermal | 0.15 | 40/160 | 0.5 (230° C.) | 1 | Unknown | Thermodynamically |
| plateau pressure | (300° C.) | (211° C.) | 1.5 (255° C.) | (225° C.)** | | very high* |
| (bar) | | | | | | |
| Cycle life stability | Good | Good | Unknown | Unknown | Not an issue | Not an issue |
| | | | NH₃ issue? | | | |
| Regeneration | N/A | N/A | N/A | N/A | Very difficult | Hi T process |
| off-board | | | | | | |
| Energy efficiency | | | | | Current | Favorable |
| | | | | | tech-unfavorable | |
| Critical | Very low | Low | Low | High release | High energy | To be proven. |
| disadvantages | release | reversible | reversible | temp. | consumption and low | |
| | pressure | hydrogen | hydrogen | | hydrogen mass % | |
| | | mass % | mass % | | | |

*At 200° C., Reaction (1b) has an equilibrium hydrogen pressure of 10⁷ atm.
**This is the predicted equilibrium pressure. However, the kinetic rates were too slow for direct measurements at these temperatures.

### Example 4

Another examination of the overall energy efficiency of one proposed embodiment is examined, through calculating the total energy required to produce one mole of hydrogen.

1) Dehydrogenation reaction: (the reaction takes place at 300° C.)

$$LiOH + LiH \to {Li}_{2} O + {H}_{2} \\ {Δ}_{r} {H}_{1} ( 573 K ) = - 20.638 kJ \text{/} mol H 2 \\ \begin{matrix}{Q}_{1} = {\int }_{298 K}^{573 K} Cp ( LiOH ) \cdot d T + {\int }_{298 K}^{573 K} Cp ( LiH ) \cdot d T + {Δ}_{r} {H}_{1} ( 573 K ) \\ = 16.390 + 10.513 + ( - 20.638 ) \\ = 6.264 kJ \text{/} mol {H}_{2}\end{matrix} \qquad ( 1 )$$

2) Regeneration of LiOH (the reaction takes place at room temperature)

Li₂O+H₂O→2LiOH ΔᵣH₂(298K)=−91.29 kJ/mol

Q₂=ΔᵣH₂(298K)=−91.29 kJ/molH₂ (2)

3) Regeneration of LiH (the reaction takes place at 500° C.)

$$LiOH + Mg \to LiH + MgO$$

$${Δ}_{r} {H}_{3} ( 773 K ) = - 227.993 kJ \text{/} mol LiH$$

$$\begin{matrix}{Q}_{3} = {\int }_{298 K}^{773 K} Cp ( LiOH ) \cdot d T + {\int }_{298 K}^{773 K} Cp ( Mg ) \cdot d T + {Δ}_{r} {H}_{3} ( 773 K ) \\ = 51.840 + 13.156 + ( - 227.933 ) \\ = - 162.997 kJ \text{/} mol LiH\end{matrix}$$

4) Regeneration of Mg (assume the reaction takes place at 1300° C.)

$$MgO + C = Mg ( g ) + CO ( g )$$

$${Δ}_{r} {H}_{4} ( 1573 K ) = 601.7 kJ \text{/} mol Mg$$

$$\begin{matrix}{Q}_{4} = {\int }_{298 K}^{1573 K} Cp ( MgO ) \cdot d T + {\int }_{298 K}^{1573 K} Cp ( C ) \cdot d T + {Δ}_{r} {H}_{4} ( 1573 K ) \\ = 48.508 + 18.527 + 601.7 \\ = 668.735 kJ \text{/} mol Mg\end{matrix}$$

In this case, the total energy required for production of one mole of H₂ is 420.712 kJ. Thus, the energy content of H₂ is 68% of the energy required for regeneration. Once again, the embodiment in accordance with the present invention is energetically favorable.

### CONCLUSION

Finally, compared to the current methods of hydrogen storage, the methods of the present invention are hybrid methods that have distinctive advantages. First of all, the hydrogen desorption Equation (1) produces up to about 8.8 wt % of hydrogen which is higher than the reversible hydrogen storage capacity within a temperature range of about <300° C. of any other known materials to date. Further; the recharge of hydrogen of the current system can be done by the reaction with water. Although this method of recharging is not appropriate for on-board processes, it can actually be an advantage to recharge off-board with respect to recharging using high pressure H₂ gas on-board. On the other hand, unlike some other solid materials that are under consideration, the product of hydrogen release in this method is a solid oxide (Li₂O), which is another advantage with respect to handling, transportation, and safety.

The above also shows that the proposed technology can be used as a hydrogen production process. The attractiveness of the process is that all hydrogen that is produced in Equation (1) is derived from water. As mentioned earlier, as long as the Mg metal that is required for completing the cycle is produced from MgO using renewable energy, this method is a promising method for commercial hydrogen production that is likely to be both economically viable and environmental friendly.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A process of forming lithium hydride for use in storing and producing hydrogen, comprising:
reacting lithium oxide with water to form a regenerated lithium hydroxide; and
reacting the regenerated lithium hydroxide with magnesium to form magnesium oxide and a regenerated lithium hydride.

2. The process of claim 1, further comprising reacting the magnesium oxide with carbon to form a regenerated magnesium.

3. The process of claim 2, wherein the reacting the magnesium oxide with carbon is performed at a temperature from about 1300° C. to about 1600° C.

4. The process of claim 1, further including thermally reducing the magnesium oxide to form regenerated magnesium.

5. The process of claim 1, further including electrolytically converting magnesium oxide to form regenerated magnesium.

6. The process of claim 1, wherein the process is substantially free of external sources of hydrogen as hydrogen gas (H₂).

7. The process of claim 6, wherein substantially all external sources of hydrogen are H₂O.

8. The process of claim 6, wherein the process is substantially free of hydrogen gas as an intermediate during any step of the process.

9. The process of claim 1, further comprising reacting the regenerated lithium hydride to form hydrogen and lithium oxide.

10. The process of claim 9, wherein the reacting lithium hydride further includes reacting lithium hydride with lithium hydroxide to form lithium oxide and hydrogen.

11. The process of claim 10, wherein the lithium hydroxide is lithium hydroxide hydrate.

12. The process of claim 11, further comprising the step of forming a regenerated lithium hydroxide by reacting a first portion of the lithium oxide with water.

13. The process of claim 12, wherein the forming regenerated lithium hydroxide and the forming regenerated lithium hydride occur substantially simultaneously.

14. The process of claim 9, wherein the reacting lithium hydride further includes reacting lithium hydride with water to form lithium oxide and hydrogen.

15. The process of claim 9, further comprising using at least some of the hydrogen produced as a fuel.

16. The process of claim 1, wherein at least one of the lithium hydroxide and regenerated lithium hydride includes a filler material.

17. A method for storing and producing hydrogen to be used as a fuel comprising the steps of:
reacting lithium oxide with water to form regenerated lithium hydroxide;
reacting at least a portion of the lithium hydroxide with magnesium to form regenerated lithium hydride and magnesium oxide;
reacting the magnesium oxide with carbon to form a regenerated magnesium; and
reacting the regenerated lithium hydride to form lithium oxide and hydrogen.

18. A system for storing and producing hydrogen comprising:
a hydrogen storage enclosure;
a fuel cell operatively connected to the hydrogen storage enclosure and including an amount of lithium hydroxide, an amount of lithium hydride, an amount of magnesium, and an amount of water; and
a hydrogen outlet operatively connected to the fuel cell.

19. The system of claim 18, wherein the amount of magnesium is supplied in a removable magnesium cartridge.

20. The system of claim 18, wherein the amount of lithium hydroxide and lithium hydride is supplied in a removable lithium cartridge.
